(19) United States
(12) Patent Application Publication
(10) Pub. No.: US 2011/0103618 A1
(43) Pub. Date: May 5, 2011

(54) AUDIO SWITCH FOR PERFORMING AUDIO SIGNAL SWITCHING

(75) Inventors: Bertrand Lemellat, Angers (FR); Claudio Schait, Meilen (CH); Jean-Claude Bini, Vence (FR)

(73) Assignee: ST-Ericsson SA, Geneva (CH)

(21) Appl. No.: 12/670,389

(22) PCT Filed: Jul. 21, 2008
(86) PCT No.: PCT/IB2008/052921

§ 371 Date: Jan. 21, 2011

(30) Foreign Application Priority Data
Jul. 26, 2007 (EP) 07113159.3

(51) Int. Cl. H04B 1/00; H02B 1/00

(52) U.S. Cl. 381/119; 381/123

(57) ABSTRACT

An audio switch for audio signal switching includes input ports for obtaining digitized audio input signals, output ports for outputting a number of analog audio output signals, and a digital matrix first stage for switching a digitized audio input signal derived from one or more of the input ports, to any one of a plurality of digital stage output ports according to a specified configuration, so as to give a number of digital stage output signals. The audio switch further includes digital-to-analog converters connected to the digital stage output ports for performing digital-to-analog conversion on a number of the digital stage output signals to obtain a number of analog audio signals and to an analog second stage for switching a number of the analog audio signals to one or more of the analog audio output ports according to a specified configuration.

### FIELD OF THE INVENTION

The invention relates to an audio switch for performing audio signal switching. The invention further relates to a method of performing audio signal switching. The invention also describes an electronic device.

### BACKGROUND OF THE INVENTION

Advances in the field of telecommunications, consumer electronics and semiconductor technology have led to the development of compact and versatile consumer devices that can perform more than one function. For example, compact MP3 players can also receive radio broadcasts, personal digital assistants (PDAs) can also access the internet, and mobile telephones can also be used to play music on external loudspeakers. The trend is towards such useful devices with an additional high entertainment value.

Consumer electronic devices of the types mentioned above are also becoming more and more compact as developments in design and manufacture lead to miniaturisation of the components such as loudspeakers, cameras, user interfaces, etc. Advances in integrated circuit design allow many signal processing functions to be realised on very small areas of silicon. Known techniques for testing and verification allow such complex digital circuits to be verified before going into production. While digital components can be very successfully miniaturised, this is not necessarily the case for analogue components, which, by their nature, require more volume. Furthermore, testing and verification of analogue components are also more costly. Another major disadvantage of analogue circuitry is its unfavourable power consumption, particularly in a device which is battery-powered. Therefore, for any compact modern consumer electronics device which outputs audio signals, it is desirable to minimise the amount of analogue circuitry involved. In one state of the art approach given by US 2004/0178941 A1, the number of digital inputs are minimised by combining or encoding pairs of digital signals according to a combining rule, so that less analogue connections are required. The number of digital inputs is reduced, but this technique requires more analytical overhead and additional clocking signals. Furthermore, the steps of encoding and decoding introduce additional delays into the data path.

### OBJECT AND SUMMARY OF THE INVENTION

Therefore, it is an object of the invention to provide an economical and straightforward way of performing audio switching for multiple inputs and outputs, in particular for the above mentioned applications.

To this end, the present invention provides an audio switch for performing audio signal switching, which audio switch comprises a plurality of input ports for obtaining digitised audio input signals, a plurality of audio output ports for outputting analogue audio output signals, and a digital matrix first stage for switching a digital stage input, derived from one or more of the input ports, to any one of a plurality of digital stage output ports according to a specified configuration to give a number of digital stage output signals. The audio switch further comprises a plurality of digital-to-analogue converters, connected to the digital stage ports of the digital matrix first stage, for performing digital-to-analogue conversion on a number of the digital stage output signals to obtain a number of analogue audio signals, and an analogue second stage for switching a number of the analogue audio signals to one or more of the analogue audio output ports according to a specified configuration.

The digitised audio input signals can comprise, for instance, MP3 music, a digitised telephone ring-tone, digitised telephone speech input, etc., or any other digitised audio signal that can arise in consumer electronics devices. The audio output ports can comprise ports for connection to loudspeakers, such as stereo loudspeakers integrated in a device or a stereo headset, for example for use in a hands-free situation.

One obvious advantage of the method according to the invention is that, by distributing the audio switching over a digital stage and an analogue stage, there are less validation tests to be run on the finished audio switch compared to a full analogue solution. Furthermore, since there are less analogue paths in the analogue stage of an audio switch according to the invention compared to a state-of-the-art audio switch, a better yield in production can be obtained for the reasons mentioned in the introduction. Also, the audio signals are switched through without any additional delay in the audio path for encoding or decoding, unlike the method proposed by the prior art mentioned in the introduction. By reducing the amount of functionality that needs to be carried out by the analogue switch, an advantageous reduction can be obtained in the power consumption of a device incorporating such an audio switch. Also, since the digital stage can be very compactly realised in hardware, a further miniaturisation can be obtained using the audio switch according to the invention. Furthermore, a realisation of the digital matrix stage using semiconductor logic building blocks such as combinational gates and multiplexers allows a relatively simple configuration of the digital matrix stage, as will be appreciated by a person skilled in the art. Because the audio switch according to the invention is neither purely digital nor purely analogue, but is a mixture or hybrid of both, the audio switch is also referred to as a ‘hybrid audio switch’ or simply ‘hybrid switch’ in the following.

An appropriate method of performing audio signal switching comprises the steps of obtaining a number of digitised audio input signals, and switching a digital stage input—derived from one or more of the digitised audio input signals—in a digital matrix first stage to any one of a number of digital stage output ports, according to a specified configuration, to give a number of digital stage output signals. Here, the term ‘derived from’ merely indicates that the digital stage input can be an unmodified digitised audio input signal (for example an MP3 input stream from a memory) or a combination of more than one digitised audio input signals (for example a ring-tone mixed with an MP3 input stream). Digital-to-analogue conversion is subsequently performed on a number of the digital stage output signals to obtain a number of analogue audio signals, and a number of the analogue audio signals is switched in an analogue second stage, according to a specified configuration, to one or more of a plurality of analogue output ports.

The dependent claims and the subsequent description disclose particularly advantageous embodiments and features of the invention.

The inputs to the hybrid switch can originate from audio input ‘channels’. An audio ‘channel’ can comprise a single mono signal, for example the speech signal received during a telephone conversation. An audio channel can also comprise a pair of signals—a ‘left’ signal and a ‘right’ signal—for a stereo audio channel, for example from a source of music, an audio-book, a podcast, etc., so that an audio output, also comprising a left and a right channel, can be listened to in stereo quality. The input ports of the digital matrix stage of the hybrid switch can therefore comprise digitised mono signals or one or more pairs of ‘left’ and ‘right’ digitised stereo signals.

In a hybrid switch according to the invention, each digital input of the digital matrix stage can be switched to any of the digital outputs. The digital matrix stage could conceivably comprise a single large multiplexer to switch any of the digital inputs to any of the digital outputs. However, this would require a large physical realisation. The functionality of such a multiplexer can advantageously be spread over a number of smaller multiplexers. Therefore, in a particularly preferred embodiment of the invention, the digital matrix stage preferably comprises a plurality of digital multiplexer switches, each of which can be realised to perform switching of input digital signals in a different manner, so that any combination of any of the digital input ports can be obtained at the output ports of the digital matrix stage. These multiplexers are particularly preferably arranged in a cascade manner, i.e. in a number of consecutive stages in the direction of data flow.

The audio switch according to the invention preferably includes a mixing unit for mixing at least two digitised audio input channels to provide a digital stage input. Such a mixing unit is generally used to overlay one digitised audio signal over another, so that, for example, a ring tone is superimposed on an MP3 stream. In this way, a user listening to music can be alerted about an incoming call without the music being interrupted. Such a mixing unit can be realised as part of the digital first stage, or can be realised as a separate component whose outputs are connected to the inputs of the digital matrix first stage. The person skilled in the art will be familiar with the functionality of such a mixing stage, so that this need not be described in any detail here. Such a mixing unit could also conceivably be realised to carry out other signal processing functions. The mixing unit might be able to compute a mono signal from a stereo channel, for example it might compute a bass signal from a left channel component and a right channel component of a stereo signal.

As mentioned above, the hybrid switch can be used in a small portable consumer electronics device such as a player or a mobile telephone. Design requirements dictate that components for such devices be as small and compact as possible, so that the devices themselves can be made to be small and light. The analog second stage together with the digital-to-analogue converters are collectively referred to in the following as an ‘analogue unit’, which analogue unit comprises all of the analogue circuitry required in a hybrid switch according to the invention. The digital matrix stage and the analogue unit of the hybrid switch can both be realised as semiconductor circuits, so that, in a preferred embodiment of the invention, both stages are realised as a single unit or entity, i.e. on a single semiconductor wafer or chip.

As mentioned in the introduction, consumer electronics devices such as mobile phones are expected to be able to perform functions other than just telephony, for example they should be able to play music or receive radio broadcasts, surf the internet, etc. Therefore, an electronic device according to the invention comprises a plurality of sources of digitised audio signals and a plurality of analogue audio outputs or output ports. A digitised audio signal can be, for example, an MP3 music file from a memory of the electronic device or an audio file downloaded by the electronic device from the internet. Alternatively, a digitised audio signal can be obtained externally, for example from a source of MP3 music such as a memory stick connected in some way to the electronic device, for example via a USB (Universal Serial Bus) interface. Naturally, the digitised audio signal could also be a speech signal received during a telephone call carried out using the electronic device. The analogue audio outputs can be, for example, the loudspeaker of the electronic device, or one or more external loudspeakers or a headset connected, for example, via an output jack of the electronic device. To perform audio signal switching from one or more of the digitised audio signals to some combination of the analogue audio outputs, according to a specified configuration, the electronic device comprises an audio switch as described above. The electronic device according to the invention can preferably be any consumer electronics device with audio input and outputs, such as a player or communications device or a combination of such devices, for example a mobile phone with the capability of playing music files.

The user of an electronic device according to the invention can preferably choose a certain configuration for a particular situation. Therefore, in a particularly preferred embodiment of the invention, the audio switch according to the invention also comprises a configuration signal input for configuring the digital first stage and/or the analogue second stage such that certain digitised audio input signals are switched to one or more specific audio output ports. The configuration signal causes the digital matrix stage and the analogue second stage of the audio hybrid switch to perform according to a certain pre-defined configuration. For example, a digital matrix stage can be realised to perform one or more of the following functions: to provide a direct input to output path, to swap an input to an output, or to copy an input to both outputs. In other words, the digital matrix stage can behave in different ways according to the different configurations. In a similar way, the analogue second stage can be configured so that a single input is copied to more than one output, or that more than one input is summed to a single output. The analogue second stage can further be realised to allow a differential output on output pairs, for example to permit a pair of loudspeakers to be connected as a bridge-tied load. Such different programmable connections in the analogue second stage permit this to behave in different ways according to the different configurations. A manufacturer of an electronic device can therefore, with relatively little effort, configure the audio hybrid switch to offer certain functions to potential users. The analogue second stage is in effect an analogue switch matrix, and may sometimes be referred to as such. Another term for this unit is ‘analogue front end’, since it presents the final stage before outputting the analogue signals to the rendering devices such as loudspeakers.

The actual configuration chosen or activated by the user can vary from situation to situation. For example, when the user is alone, he might like to listen to a radio broadcast received by his electronic device or to music stored on the electronic device, using earphones. If the electronic device is a communications device such as a mobile phone, and an incoming call is being received, the user might prefer that the speech signal should replace the music for the duration of the call. In a different situation, for example when the user is with a group of people, the electronic device can be used to play music via external loudspeakers, so that everyone can enjoy the music. In the event of an incoming call, the user might prefer to receive the call via a headset, so that the other people in the group can continue to listen to the music, while the user can take care of the telephone conversation. Using a different configuration, the speech signal from an incoming call can be routed to external loudspeakers, so that other listeners can also hear what the caller is saying. Alternatively, in a situation in which the device is being used to share music between listeners, a configuration can cause an incoming call to be routed to a headset, so that the user of the device can hear the caller and not the music, while the other listeners continue to hear the music, but not the caller. Evidently, these configurations can be stored in advance as ‘preferences’, for example in a configuration step, so that, when one of the described situations arises, the device performs the audio switching automatically, without any additional action required. Alternatively, the configuration can be changed “on the fly”, allowing the user to choose the configuration most suitable for the current situation. This versatility and ease of use make a electronic device including such a hybrid switch particularly attractive from the point of view of the user.

An electronic device according to the invention preferably comprises a user interface such as the usual type with a display, keypad, soft keys and other types of buttons or joystick for allowing a user to specify an audio configuration. Software of the electronic device can offer the user a number of predefined configurations from which he can choose. These can be presented graphically as a selection, for example, in the display of the electronic device, and the user can choose one of the proffered configurations. For example, he might choose that an incoming call be always routed to the headset while music is being played on external loudspeakers connected to the electronic device. A configuration signal generation unit of the electronic device can then generate a configuration signal according to the choice made by the user. Depending on the realisation of the electronic device, it may also be possible for the user himself to define a specific audio configuration using the input modalities of the electronic device.

The steps of the method described above can be carried out by appropriate digital hardware and software modules. Software modules for applying a configuration to the digital matrix stage and to the analogue stage can run on a microprocessor. A computer program product comprising such software modules can be directly loaded into the memory of a programmable device, such as a processor, for use in an electronic device according to the invention, or in any other device comprising an audio hybrid switch according to the invention.

Other objects and features of the present invention will become apparent from the following detailed descriptions considered in conjunction with the accompanying drawing. It is to be understood, however, that the drawings are designed solely for the purposes of illustration and not as a definition of the limits of the invention.

### BRIEF DESCRIPTION OF THE DRAWINGS

FIG. 1 shows a block diagram of an audio switch as known from the state of the art;

FIG. 2 shows a block diagram of a hybrid audio switch according to a first embodiment of the invention;

FIG. 3a is a block diagram showing the switching connections for a number of channels in the hybrid audio switch of FIG. 2, according to a first audio configuration;

FIG. 3b is a block diagram showing the switching connections for a number of channels in the hybrid audio switch of FIG. 2, according to a second audio configuration;

FIG. 3c is a block diagram showing the switching connections for a number of channels in the hybrid audio switch of FIG. 2, according to a third audio configuration;

FIG. 3d is a block diagram showing the switching connections for a number of channels in the hybrid audio switch of FIG. 2, according to a fourth audio configuration.

FIG. 4 shows a block diagram of a hybrid audio switch according to a second embodiment of the invention;

FIG. 5a shows a schematic representation of a communication device according to an embodiment of the invention.

FIG. 5b schematically indicates the inclusion of a hybrid switch according to the invention in the communication device of FIG. 5a.

### DESCRIPTION OF EMBODIMENTS

In the diagrams, like numbers refer to like objects throughout. Objects shown in the diagrams are not necessarily drawn to scale. In the diagrams, it is assumed that the electronics device incorporating the hybrid switch is a communications device such as a mobile telephone, without restricting the invention in any way. A communication device is used as an example since the hybrid switch is most advantageously used in such a device, having relatively many audio inputs and outputs which must be configured in a convenient and intuitive manner from the points of view of the manufacturer and the user.

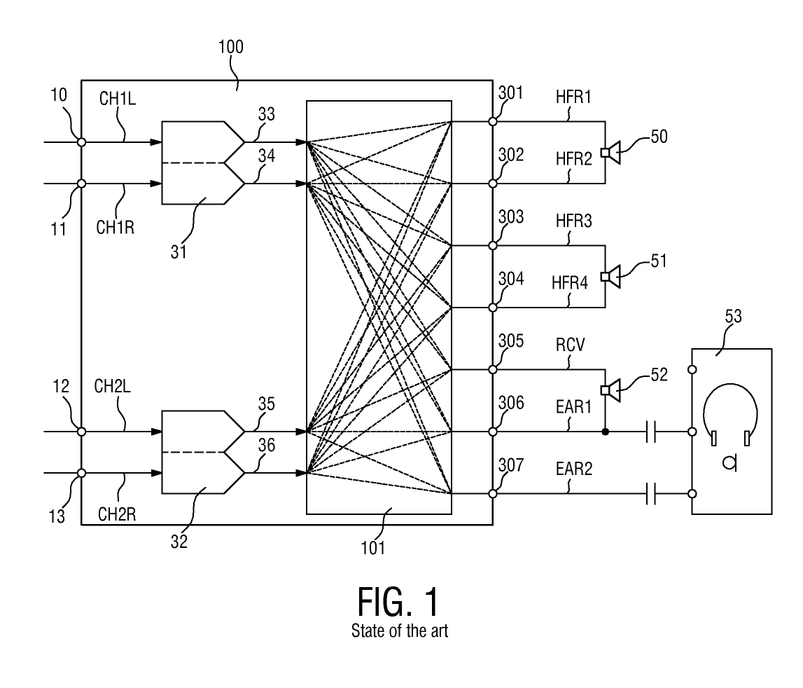

FIG. 1 shows a block diagram of an audio switch 100 as known from state of the art solutions. This audio switch 100 comprises a number of input ports 10, 11, 12, 13 for receiving input signals CH1L, CH1R, CH2L, CH2R from a pair of stereo input channels, and digital-to-analog converters 31, 32, one for each input channel. Analogue audio signals 33, 34, 35, 36 output by the digital-to-analog converters 31, 32 are routed or switched in an analogue switch matrix 101 to the desired audio output ports 301, 302, 303, 304, 305, 306, 307 to exit as analogue audio output signals HFR1, HFR2, HFR3, HFR4, RCV, EAR1, EAR2 respectively, which are in turn connected as appropriate to loudspeakers 50, 51, a speaker/receiver 52 or a headset 53. Here, the notation used indicates standard practice abbreviations, where ‘HFR’ stands for ‘hands-free’, ‘RCV’ stands for ‘receiver’, and ‘EAR’ stands for ‘earphone’. However, the invention is not restricted in any way to use in such a set-up. In order to be able to route any of the analogue signals 33, 34, 35, 36 to any desired output port 301, 302, 303, 304, 305, 306, 307, the analogue switch matrix 101 must be realised to include all the necessary unitary connections. A unitary connection is a dedicated or hard-wired connection between an input and an output. The more configurations available, the more unitary connections are required. Because of the multitude of required connections, such state of the art audio switches are generally expensive to manufacture and verify. In the realisation shown, a large number of unitary connections are required to be able to switch an input signal CH1L, CH1R, CH2L, CH2R to any of the seven output ports 301, 302, 303, 304, 305, 306, 307. Evidently, an even larger number of unitary connections will be required for a full analogue realisation comprising more than just the four input ports shown here. Furthermore, the large amount of silicon area required means that such a switch is bulky, making it unsuitable for use in modern miniaturised devices.

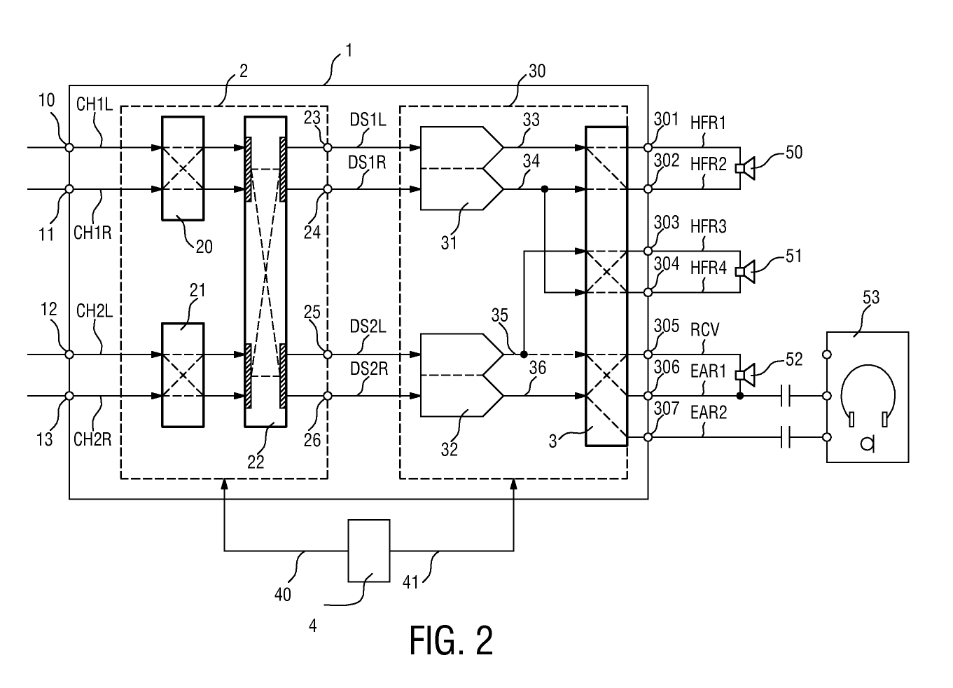

FIG. 2 shows a hybrid audio switch 1 according to an embodiment of the invention. Here, the hybrid switch 1 comprises a digital matrix first stage 2 and an analogue second stage 3 with a number of audio output ports 301, 302, 303, 304, 305, 306, 307 for outputting analogue audio output signals HFR1, HFR2, HFR3, HFR4, RCV, EAR1, EAR2. The actual audio output signals HFR1, HFR2, HFR3, HFR4, RCV, EAR1, EAR2 of the hybrid switch will generally need to be buffered or amplified before outputting the sound over a loudspeaker, as will be known to a person skilled in the art. For the sake of clarity, the necessary amplifiers are not shown in the diagram. Input signals CH1L, CH1R, CH2L, CH2R enter the audio switch 1 at the input ports 10, 11, 12, 13. The input signals CH1L, CH1R, CH2L, CH2R are named using the usual notation since these are usually stereo audio channels. Generally, in the case of stereo signals in applications such as these, it can be arbitrary which signal is routed to a ‘left’ or ‘right’ audio output, since it is the difference in these signals that results in the stereo listening effect. Although only two stereo input channels are shown, it will be evident that the invention is not limited to two input channels, and that the hybrid switch 1 can be realised to handle a greater or lesser number of inputs. The same applies to the number of audio outputs, seven in this example embodiment. It will be clear that the hybrid switch 1 can be realised to have less or more audio outputs.

In this embodiment of the audio hybrid switch 1, the digital matrix first stage 2 comprises three multiplexer stages 20, 21, 22. Following the conventions of circuit diagrams, the signal flow is to be understood from “left to right”, i.e. signals ‘enter’ on the left-hand side of the diagram and ‘exit’ on the right-hand side. This convention allows the dashed lines in the digital stages 20, 21, 22 to be drawn without the usual arrow heads indicating signal direction flow. The first two stages 20, 21 each have two signal inputs and two signal outputs. Either of the signal inputs can be switched to either of the signal outputs, as indicated by the dashed lines. The following digital multiplexer stage 22 has a slightly different functionality. This stage 22 has two channel inputs, i.e. each input to this block 22 is in fact a channel with a ‘left’ and ‘right’ signal component. Each channel input is switched to either of the channel outputs of this block 22. Again, the dashed lines in this block 22 indicate the routes that each of the inputs can take to the outputs. The solid bars at the inputs and outputs of this block 22 emphasize the fact that an entire channel is switched, and not just a signal. The outputs of block 22 leave the digital matrix first stage 2 at the output ports 23, 24, 25, 26 as the digital stage output signals DS1L, DS1R, DS2L, DS2R respectively, and enter a following analogue unit 30. The realization of the output ports 23, 24, 25, 26 of the digital matrix first stage 2 depends on whether the digital matrix first stage 2 is realized as a stand alone entity, or as in this example as integrated with the analogue unit 3 in the hybrid switch 1.

The analogue unit 30 comprises a pair of digital-to-analog converters 31, 32 and an analogue second stage 3. The digital stage output signals DS1L, DS1R, DS2L, DS2R are routed as shown in the diagram to the inputs of the digital-to-analog converter pairs 31, 32. Each digital-to-analog converter 31, 32 can process two input signals, so that, in this embodiment, a maximum of four analogue audio signals 33, 34, 35, 36 can be obtained. The analogue signal 33 is obtained from the digital signal DS1L, the analogue signal 24 is obtained from the digital signal DS1R, etc. These analogue audio signals 33, 34, 35, 36 are routed to an analogue second stage 3, or analogue switching matrix 3. The analogue second stage 3 is realised so that each of the analogue audio signals 33, 34, 35, 36 can be routed to one or more output ports 301, 302, 303, 304, 305, 306, 307 and thus to a corresponding analogue audio output signal HFR1, HFR2, HFR3, HFR4, RCV, EAR1, EAR2. Since the digital matrix stage 2 takes care of a large part of the switching functionality, the analogue second stage 3 need only provide a reduced number of unitary connections. For the example shown, the number of unitary connections has been reduced by 30% compared to a full analogue switching solution, as indicated by the dashed lines in block 3. A comparison with the analogue front end 101 of FIG. 1 demonstrates the marked reduction in the number of unitary connections required. The current configuration, i.e. the active signal routing through the digital matrix stage 2 and the analogue second stage 3, is specified by a configuration signal generation unit 4, which supplies a configuration signal 40 for the digital matrix stage 2 and another configuration signal 41 for the analogue second stage 3.

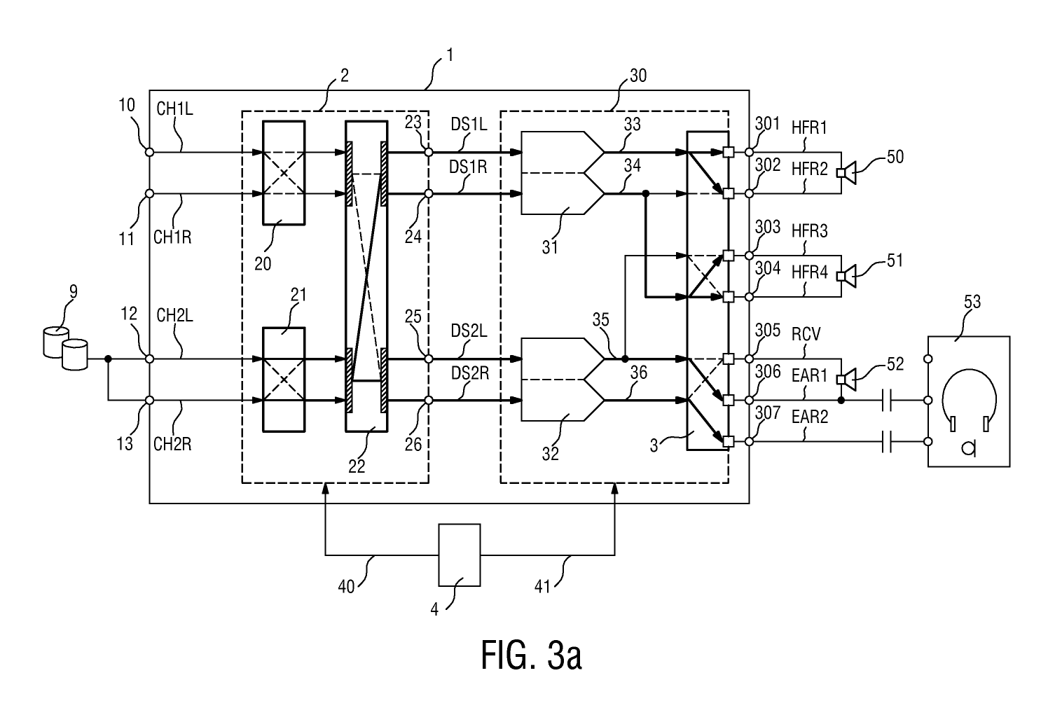

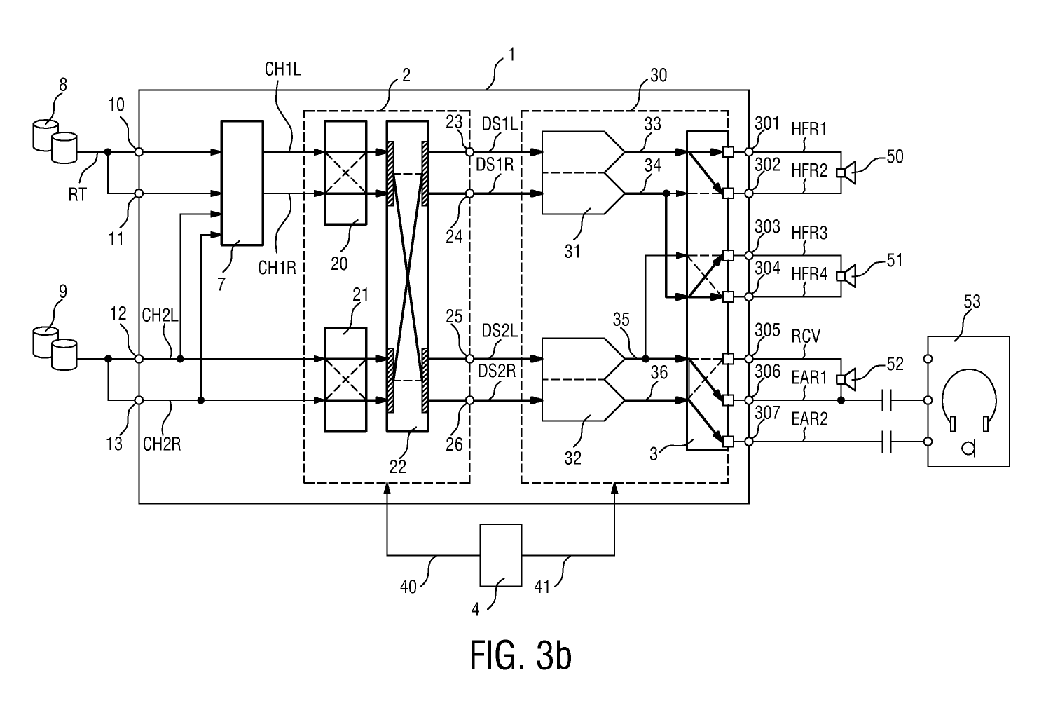

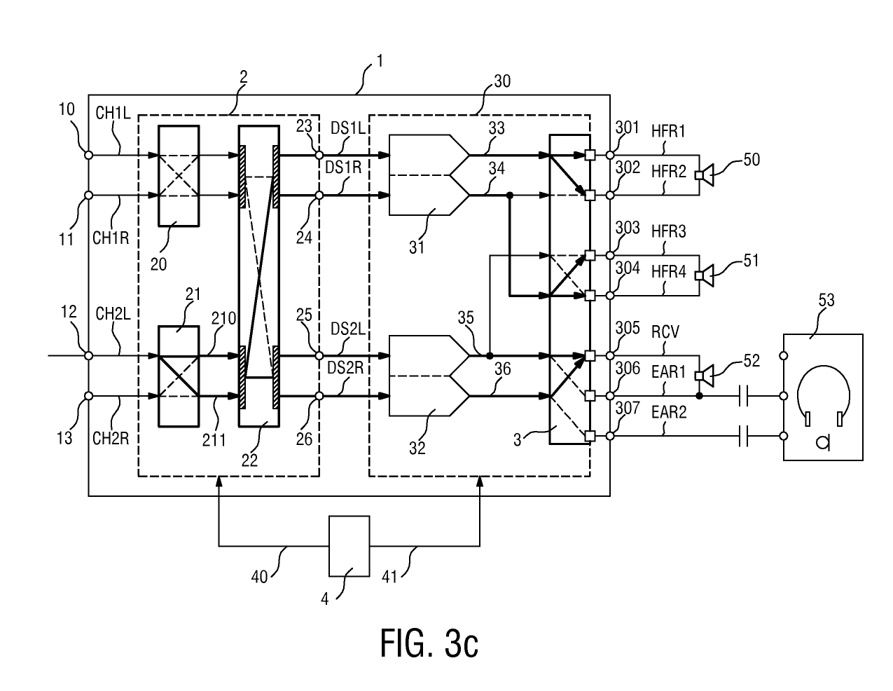

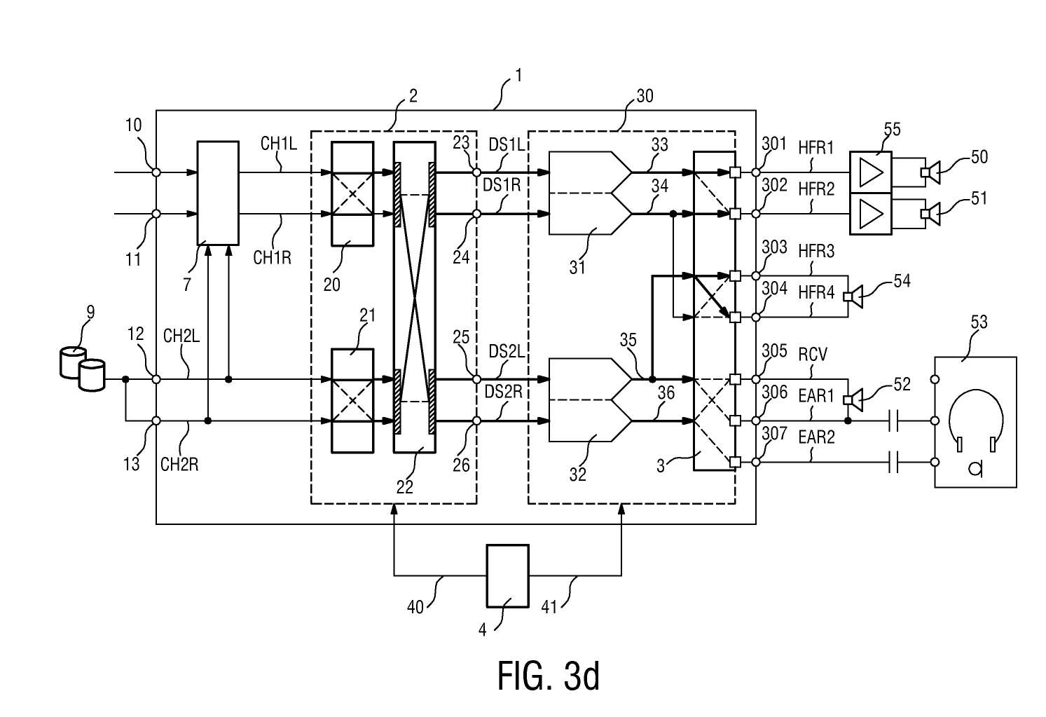

The following FIGS. 3a-3d show how the audio hybrid switch 1 can be used to route digital input audio signals to analogue audio outputs for different configurations. These diagrams show only a few of the many configurations that are possible. Evidently, any number of possible configurations can be obtained by appropriate design of the digital matrix first stage 2 and the analogue second stage 3. Although not shown in the diagrams, it is assumed that the device in which the audio hybrid switch 1 is incorporated is a mobile telephone. The user of the device, and any other listeners are not indicated in the diagrams. The acoustic elements—loudspeakers 50, 51, speaker/receiver 52, headset 53—shown in the diagrams can be incorporated in the device or externally to the device, as will be made clear. Each of the diagrams shows a different configuration, which, as already described above, can be predetermined by the manufacturer for later selection by a user or automatic activation, depending on the current situation. In each case, the currently active configuration is specified by the configuration signal generation unit as described in FIG. 2. The paths followed by the audio signals in each configuration are indicated by the solid lines.

FIG. 3a shows a first audio configuration. The digital matrix stage 2 is configured to route digitised input signals CH2L, CH2R from a single audio source 9, for example a memory containing a collection of MP3 music files, to both digital-to-analogue converters 31, 32. The analogue second stage 3 is configured to forward the outputs 33, 34, 35, 36 of the digital-to-analogue converters 31, 32 to the outputs 301, 302, 303, 304 to give loudspeaker signals HFR1, HFR2, HFR3, HFR4 for a pair of stereo loudspeakers 50, 51 and also to the outputs 306, 307 to give headset signals EAR1, EAR2. This configuration allows an audio file from the single audio source 9 to be played on more than one output, i.e. stereo loudspeakers 50, 51 and a headset 53. In this way, the user can be listening to music over the earphones of the headset 53, and the music can also be output over the dual loudspeakers 50, 51 so that other listeners can also enjoy the music.

A similar configuration is shown in FIG. 3b. Here, when the mobile phone uses its two embedded loudspeakers in a stereo playback application, the audio output ports 301, 302, 303, 304 are connected so that the relevant analogue audio output signals HFR1, HFR2, HFR3, HFR4 are routed to the loudspeakers 50, 51 of a hands-free set. In this example, the loudspeakers 50, 51 of the hands-free set are connected as a bridge-tied load to increase the power output and therefore the volume of the audio output. In addition, this embodiment includes a mixing unit 7 preceding the digital matrix stage 2. The digital matrix stage 2 is configured so that input signals CH1L, CH1R of a first audio channel RT are routed to the second digital-to-analogue converter 32 (and therefore to the outputs 306, 307 to give analogue signals EAR1, EAR2 for the headset 53), and input signals CH2L, CH2R of a second audio channel CH2 are routed to the first digital-to-analogue converter 31 (and therefore to the outputs 301, 302, 303, 304 to give analogue signals HFR1, HFR2, HFR3, HFR4 for the bridge-tied load). While in this configuration, a ring-tone melody RT indicating an incoming call is retrieved from a memory 8 and is mixed with the music CH2 in the mixing unit 7, and the resulting mixed channel signals CH1L, CH1R are forwarded to the digital matrix stage 2. Using this configuration, the user can hear the ring-tone melody overlaid on the music with the headset 53, while any other listeners hear only the music over the loudspeakers 50, 51 and are not disturbed by the ring-tone.

A third audio configuration is shown in FIG. 3c, demonstrating the summation capability of the analogue second stage. Here, the user is carrying out a telephone conversation on the mobile telephone over the receiver 52. The incoming speech is received as a mono signal CH2L. Using the configuration shown, the speech signal CH2L can also be routed to the output loudspeakers 50, 51 (connected as a bridge-tied load) of the hands-free cradle, so that other listeners can also hear what the user's conversation partner is saying

In this configuration, the digital matrix stage 2 duplicates the channel input CH2L to give a ‘left’ signal 210 and a ‘right’ signal 211, and these are in turn switched by the channel-switching stage 22 of the digital matrix stage 2 to both digital-to-analogue converters 31, 32 of the analogue unit 30. The outputs of the first digital-to-analogue converter 31 are routed to the outputs 301, 302, 303, 304 to give analogue signals HFR1, HFR2, HFR3, HFR4 for the hands-free loudspeakers 50, 51. The outputs of the second digital-to-analogue converter 32 are summed to the output 305 to give the analogue signal RCV for the receiver 52.

In the fourth audio configuration shown in FIG. 3d, the music-rendering capabilities of a device with a hybrid switch are further exploited. In this configuration, an additional bass signal CH1L is computed in a bass computation unit 7 using the left and right channel components CH2L, CH2R of a stereo signal originating from a memory 9. The left and right audio channel components CH2L, CH2R are routed by the digital matrix stage 2 to the first digital-to-analogue converter 31. The outputs of the digital-to-analogue converter 31 are in turn forwarded to the outputs 301, 302 to give the analogue output signals HFR1, HFR2 which are connected, via an external buffer 55 to a pair of stereo loudspeakers 50, 51 connected as a bridge-tied load. An additional loudspeaker 54 is connected to the outputs 303, 304 of the analogue second stage 3 by analogue output signals HFR3, HFR4. This loudspeaker 54 is fed with the output of the second digital-to-analogue converter 32, i.e. the computed bass signal. Using this configuration, a small device can be used for relatively powerful audio rendering.

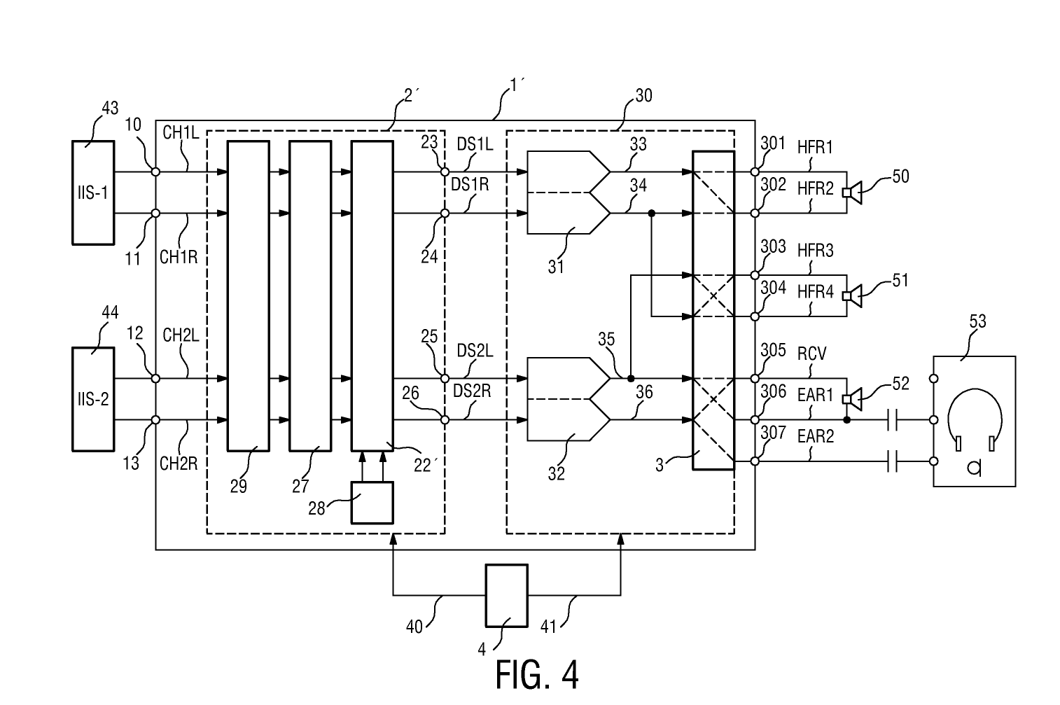

FIG. 4 shows a further development l′ of the hybrid switch 1 that was explained in FIG. 2. Here, the input channels are processed in Integrated Interchip Sound (IIS) blocks 43, 44 and transferred to the hybrid switch 1. A first switching stage 29 of a digital matrix stage 2′ is followed by a filter block 27, which serves to perform bit-stream checking and filtering on the IIS serial bus signals switched by the first stage 29. In this way, a better quality is ensured for the switched signals. The first stage 29 can also cause an input to be looped back for testing purpose. Furthermore, the functionality of this filter block 27 allows a loop-back of one or more of the input signals to be performed, to allow extensive testing of the digital matrix stage 2′. The outputs of the filter block 27 are forwarded to a channel switch 22′, similar in function to the second switching stage 22 of the hybrid switch 2 described in FIG. 2 and FIGS. 3a-3d. An additional analogue-to-digital block 28 can be used to loop an analogue signal, for example to one of the outputs of the analogue stage 3, back through the channel-switching stage 22′ of the digital matrix stage 2′. This can be useful to the manufacturer of the communication device in product verification procedures.

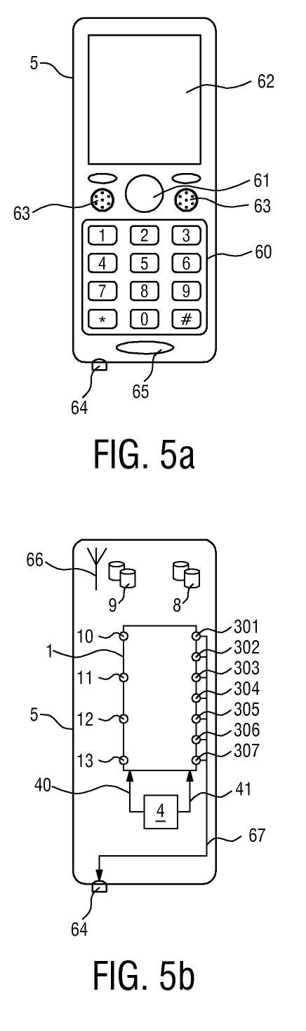

FIG. 5a shows a communication device 5 according to the invention. The device 5 shown is a mobile telephone 5 with the usual user interface comprising, as input modalities, a keypad 60, a navigator button 61, and a microphone 65. Output modalities of the mobile telephone are a display 62 and built-in loudspeakers 63. The mobile phone 5 also features an output jack 64 so that the device 5 can be connected to various accessories such as headset (not shown in the diagram). Only a very basic mobile phone 5 is shown here, but it will be clear that a more complex communication device is also implied, such as a mobile digital assistant (MDA), Blackberry®, etc.

FIG. 5b shows the outline of the communication device of FIG. 5a, and also schematically indicates the hybrid switch 1 of the invention. The device 5 includes a memory 9 for MP3 music files, and also a memory 8 for ring-tones. These memories provide stereo digital audio signals which can be input to the hybrid switch as explained above. A mobile communication interface, visually represented by an antenna 66, allows connection to the internet, which can also be regarded as a source of stereo digital signals for processing by the hybrid switch 1. Naturally, a speech input received during a call is also a source of a digitised audio signal. For the sake of clarity, the connection of these signals to the hybrid switch 1 is not shown in the diagram. Using the user interface elements described above, a user of the device 5 can select the desired current configuration, for example from a menu shown on the display. A configuration unit 4 then generates the configuration signal 40, 41 for the digital switch and the analogue switch of the hybrid switch 1. The output ports 301, 302, 303, 304, 305, 306, 307 of the hybrid switch 1 can be connected to a signal bus 67 which in turn is connected to the output jack 64 in the usual manner, as will be known to a person skilled in the art. Analogue audio signals from the chosen source(s) 8, 9, 66 or received speech are then routed via the output jack 64 to the desired target device such as an external loudspeaker or headset, according to the chosen configuration,

Although the present invention has been disclosed in the form of preferred embodiments and variations thereon, it will be understood that numerous additional modifications and variations could be made thereto without departing from the scope of the invention. For example, the invention can be used in a device in which the configurations are not accessible to the end user.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1-9. (canceled)

10. An audio switch for performing audio signal switching, comprising:
a plurality of input ports for obtaining digitized audio input signals;
a plurality of output ports for outputting a number of analog audio output signals;
a digital matrix first stage for switching a digitized audio input signal derived from one or more of the input ports, to any one of a plurality of digital stage output ports according to a specified configuration, to give a number of digital stage output signals;
a plurality of digital-to-analog converters connected to the digital stage output ports of the digital matrix first stage, for performing digital-to-analog conversion on a number of the digital stage output signals to obtain a number of analog audio signals; and
an analog second stage for switching a number of the analog audio signals to one or more of the analog audio output ports according to a specified configuration.

11. An audio switch according to claim 10, wherein the digital matrix stage comprises a plurality of digital multiplexer switches.

12. An audio switch according to claim 11, wherein the plurality of digital multiplexer switches of the digital matrix stage are arranged in a cascade.

13. An audio switch according to claim 10, further comprising:
a mixing unit for mixing at least two digitized audio input channels to provide digitized audio input signals for a digital multiplexer switch.

14. An audio switch according to claim 11, further comprising:
a mixing unit for mixing at least two digitized audio input channels to provide digitized audio input signals for a digital multiplexer switch.

15. An audio switch according to claim 12, further comprising:
a mixing unit for mixing at least two digitized audio input channels to provide digitized audio input signals for a digital multiplexer switch.

16. An audio switch according to acclaim 10, further comprising:
a configuration signal input for applying the specified configuration to the digital first stage and/or the analog second stage, such that specified digitized audio input signals are switched to specified audio output ports.

17. An audio switch according to claim 11, further comprising:
a configuration signal input for applying the specified configuration to the digital first stage and/or the analog second stage, such that specified digitized audio input signals are switched to specified audio output ports.

18. An audio switch according to claim 12, further comprising:
a configuration signal input for applying the specified configuration to the digital first stage and/or the analog second stage, such that specified digitized audio input signals are switched to specified audio output ports.

19. An audio switch according to claim 10, wherein the digital first stage, the plurality of digital-to-analog converters and the analog second stage are embodied in a single entity.

20. An audio switch according claim 16, wherein the digital first stage, the plurality of digital-to-analog converters and the analog second stage are embodied in a single entity.

21. An electronic device comprising:
a plurality of sources of digitized audio input signals;
a plurality of analog output ports; and
an audio switch capable of switching one or more of the digitized audio input signals to one or more of the plurality of output ports according to a specified configuration, said audio switch comprising:
a plurality of input ports for obtaining the digitized audio input signals;
a plurality of output ports for outputting a number of analog audio output signals;
a digital matrix first stage for switching a digitized audio input signal derived from one or more of the input ports, to any one of a plurality of digital stage output ports according to a specified configuration, to give a number of digital stage output signals;
a plurality of digital-to-analog converters connected to the digital stage output ports of the digital matrix first stage, for performing digital-to-analog conversion on a number of the digital stage output signals to obtain a number of analog audio signals; and
an analog second stage for switching a number of the analog audio signals to one or more of the analog audio output ports according to a specified configuration

22. An electronic device according to claim 21, further comprising:
a user interface for allowing a user to specify a configuration; and
a configuration signal generation unit for generating a configuration signal according to the specified configuration.

23. An electronic device according to claim 21, wherein the digital matrix stage of the audio switch comprises a plurality of digital multiplexer switches.

24. An electronic device according to claim 21, wherein the plurality of digital multiplexer switches of the digital matrix stage are arranged in a cascade.

25. An electronic device according to claims 21, wherein the audio switch further comprises:
a mixing unit for mixing at least two digitized audio input channels to provide digitized audio input signals for a digital multiplexer switch.

26. A method of performing audio signal switching, comprising:
obtaining a number of digitized audio input signals over a plurality of input ports;
switching a digitized audio input signal, derived from one or more of the input ports in a digital matrix first stage to any one of a number of digital stage output ports according to a specified configuration, to give a number of digital stage output signals;
performing digital-to-analog conversion on a number of the digital stage output signals to obtain a number of analog audio signals; and
switching a number of the analog audio signals in an analog second stage according to a specified configuration, to one or more of a plurality of analog output ports.
